(19) United States
(12) Patent Application Publication
(10) Pub. No.: US 2005/0173935 A1
(43) Pub. Date: Aug. 11, 2005

(54) Sliding litter scoop

(76) Inventors: Tapas K. Pain, Woodbridge (CA); Paul W. Dorsett, Mississauga (CA)

Correspondence Address: TAPAS K. PAIN, POST OFFICE BOX 96598, 2414 MAJOR MACKENZIE DRIVE, VAUGHAN ONTARIO, L6A 1R8, CA

(21) Appl. No.: 10/438,966

(22) Filed: Feb. 9, 2004

(51) Int. Cl. A01K 29/00; E01H 1/12

(52) U.S. Cl. 294/1.3; 294/55

(57) ABSTRACT

The present invention provides an animal refuse scoop comprising a scoop, and a handle attached to the scoop. The scoop defines a top and bottom surface, and a plurality of openings therein. The openings are defined to allow the passage of litter granules therethrough. A cover, having a solid body and a trigger attached to the solid body, is slidably attached to the scoop. The solid body defines a plurality of openings therein. The solid body is adjacent to the scoop bottom surface and is adapted to matingly cover the scoop openings in a first position to prevent the passage of granules therethrough. The cover solid body is adapted to slide to a second position by pulling of the trigger, wherein the cover solid body openings align with the scoop openings to allow the passage of granules therethrough. The scoop can be modified to switch the first and second positions.

### FIELD OF INVENTION

The present invention relates to animal refuse scoops, and more particularly to scoops for use with clumping animal litter.

### BACKGROUND OF THE INVENTION

Domesticated animals such as cats are often trained to use litter boxes for defecation and urination. These litter boxes are typically filled with some type of disposable litter, which is usually comprised of some sort of fine absorbent granules. A particularly useful type of disposable litter is a clumping litter, such as the type disclosed in Canadian patent nos. 2,323,103; 2,233,406 and 2,225,328. Clumping litter allows a user to clean the litter box by removing solidified clumps of litter, that have been coagulated together by an animal's urine, or attached to wet/fresh faeces, to form a clumped mass.

To remove such clumped masses of litter, the user should, for hygienic reasons, preferably employ a scoop. Numerous animal refuse scoops are disclosed in the prior art. Recently, animal refuse scoops have been adapted to work particularly well with clumping litter in that these scoops provide openings to allow the non-clumped granules to fall through the scoop, and back in to the litter box. For example, the scoops disclosed in U.S. Pat. No. 6,312,029 and U.S. Des. patent no. D332,675 are particularly well suited for use with clumping litter. These scoops operate as sifting scoops, which allow the user to preserve and conserve unused litter by keeping most of the unused litter in the litter box.

A problem with these sifting scoops results from the fact that very often, the user will have to travel some distance from the litter box to a place of disposal, such as a garbage can, to dispose of the clumped masses. During transport, litter granules that are held loosely to the clumped mass will typically fall away from the clumped mass, travel through the openings in the sifting scoop, and wind up on the user's floor or carpet. Cleaning these loose granules is a nuisance, and the granules having been in contact with urine and faeces, are unhygienic.

### SUMMARY OF THE INVENTION

The present invention provides an animal refuse scoop comprising a scoop, and a handle attached to the scoop. The scoop defines a top and bottom surface, and a plurality of openings therein. The openings are defined to allow the passage of litter granules therethrough. A cover, having a solid body and a trigger attached to the solid body, is slidably attached to the scoop. The solid body defines a plurality of openings therein. The solid body is adjacent to the scoop bottom surface and is adapted to matingly cover the scoop openings in a first position to prevent the passage of granules therethrough. The cover solid body is adapted to slide to a second position by pulling of the trigger, wherein the cover solid body openings align with the scoop openings to allow the passage of granules therethrough.

### DESCRIPTION OF THE DRAWINGS

FIG. 1 is a perspective view of a preferred embodiment of the present invention in a first position.

FIG. 1A is an exploded view of FIG. 1.

FIG. 2 is a side view of FIG. 1.

FIG. 3 is a cross-sectional view taken along the line 3-3 in FIG. 2.

FIG. 3A is a cross-sectional view taken along the line 3A-3A in FIG. 2.

FIG. 4 is a side view of the preferred embodiment of the present invention in a second position.

FIG. 5 is cross-sectional view taken along the line 5-5 in FIG. 1 in the first position.

FIG. 6 is a cross-sectional view similar to FIG. 5 in the second position.

FIG. 7 is a cross-sectional view similar to FIG. 6 showing an alternate second position.

FIG. 8 is a cross-sectional view similar to FIG. 5 showing an alternate first position.

### DETAILED DESCRIPTION OF THE DRAWINGS

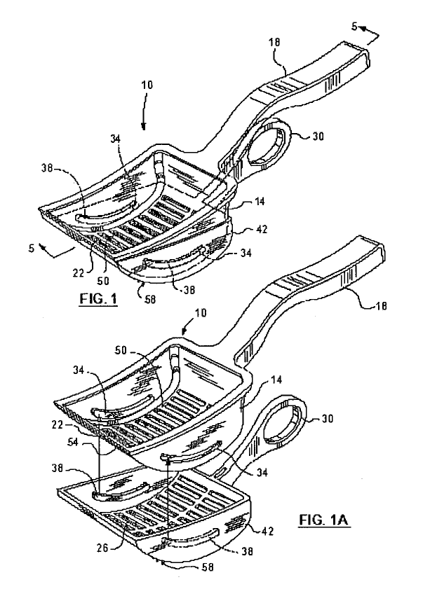

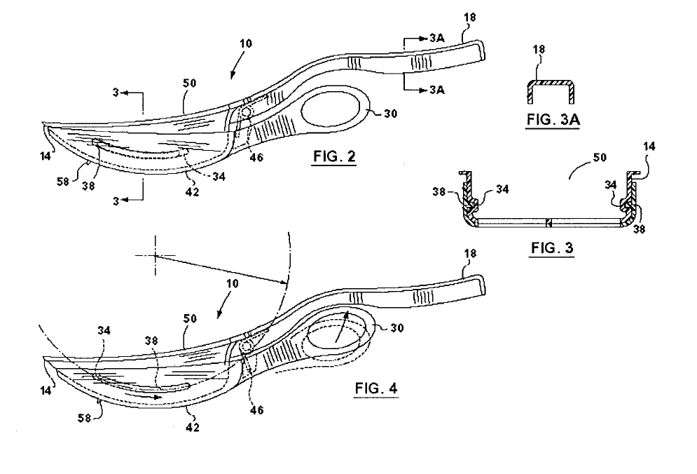

In accordance with the present invention, FIG. 1 shows a cat litter scoop (10) having a scoop portion (14) and a handle (18) attached thereto. The handle (18) is preferably hollow (see FIG. 3A).

The scoop (14) defines a top (50) and bottom (54) surface, and a plurality of openings (22) therein (the openings (22) are best seen in FIG. 1A). The openings (22) are defined to allow the passage of litter granules (68) therethrough. The openings (22) can be rectangular, circular, or any other shape or orientation so long as they permit the passage of litter granules (68) therethrough. Similarly, the scoop (14) can be any shape so long as it is functional for dragging through a cat litter box (not shown).

A cover having a solid body (42) and a trigger (30) is slidably attached to the scoop (10), and is positioned adjacent to the scoop (14) bottom surface (54). The cover body (42) defines a plurality of openings (26) to allow the passage of litter granules (68) therethrough. The cover body (42) is preferably slidably attached to the scoop (14) by way of a corresponding groove (34) and tab (38) mating arrangement (best seen in FIG. 3). The slidable attachment can also be modified to allow the cover (42) to be releasable or removable from the scoop (14) (to facilitate cleaning of the scoop (10)).

The groove (34) can be provided on the scoop (14) and the tab (38) can be provided on the cover body (42). This arrangement can be reversed so that the groove (34) is provided on the cover body (42) and the tab (38) is provided on the scoop (14).

The cover body (42) can optionally define projecting fingers (58) (best seen in FIG. 2) for raking litter in a litter box (not shown), to give the litter a smooth surface.

When in its first position (FIG. 8) (i.e. the “closed position”), the cover (42) is adjacent to the scoop (14) bottom surface (54) and adapted to matingly cover the scoop (14) openings (22). In the closed position (FIGS. 6 and 8), free litter granules (68) cannot pass through the cover openings (26). The cover (42) preferably corresponds in shape to the scoop (14) so that the cover (42) can matingly engage the scoop (14). For design purposes, the cover (42) can be of a different shape and configuration from the scoop (14), so long as the cover (42) matingly covers the scoop (14) openings (22) when in the closed position, and permits litter granules (68) to fall through the openings (22) when in the open position.

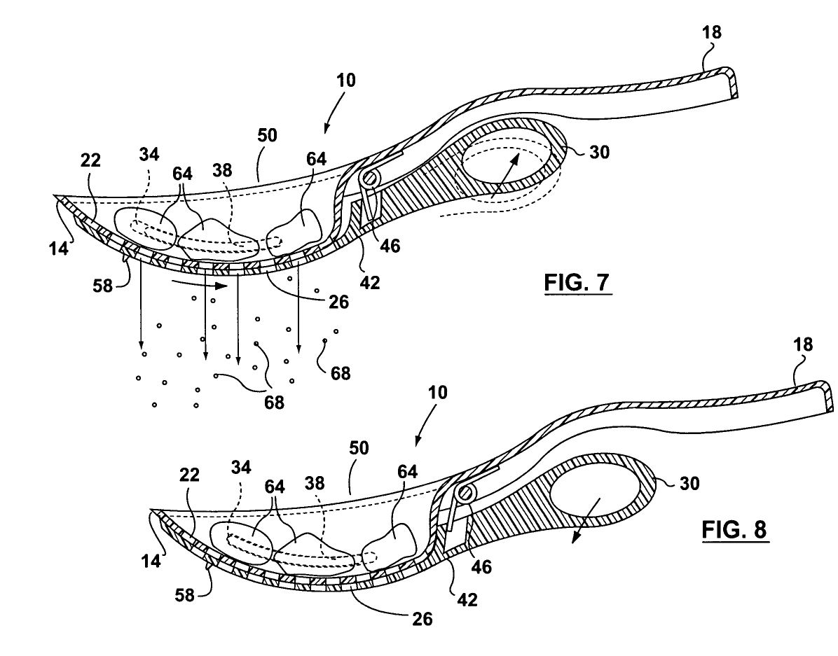

The trigger (30) is attached to the cover (42) to permit a user (not shown) to, by squeezing the trigger (30), move the cover (42) between the first position and a second position (see FIG. 7).

In the second position the openings (26) of the cover body (42) align with the openings (22) of the scoop (14), so that litter granules (68) can freely pass therethrough.

The scoop (10) can optionally be fitted with a biasing means (46) which is preferably attached to the scoop (14) and engages the cover body (42). The biasing means can bias the cover (42) into either the first or the second position, depending upon a user's preference.

In operation, the scoop (14) and cover (42) are inserted into a cat litter box (not shown) filled with clumping cat litter (not shown). The scoop (14) is dragged across and through the cat litter. While dragging the scoop (14) through the litter, the user can squeeze the trigger (30) to move the cover (42) from the closed position to the open position. If the cover (42) is maintained in the closed position during dragging, the amount of cat litter that can pass through the scoop (14) is more limited than if the cover (42) is in the open position.

When the scoop (14) is lifted out of the litter box (not shown), the user squeezes the trigger (30), resulting in the cover (42) moving to the open position. When the cover (42) is in the open position, free litter granules (68) can freely pass through both the scoop openings (22) as well as the cover openings (26). Clumped masses of litter (64) are retained within the scoop (14) while the non-clumped litter granules (68) freely pass through the openings (22, 26) and back into the litter box.

Once the free litter granules (68) have passed through the scoop openings (22, 26), the user can release the trigger (30) allowing the cover to return to the closed position (FIG. 8). The clumped masses (64) can then be transported to a site of garbage disposal without allowing the passage of free litter granules (68) through the scoop openings (22, 26).

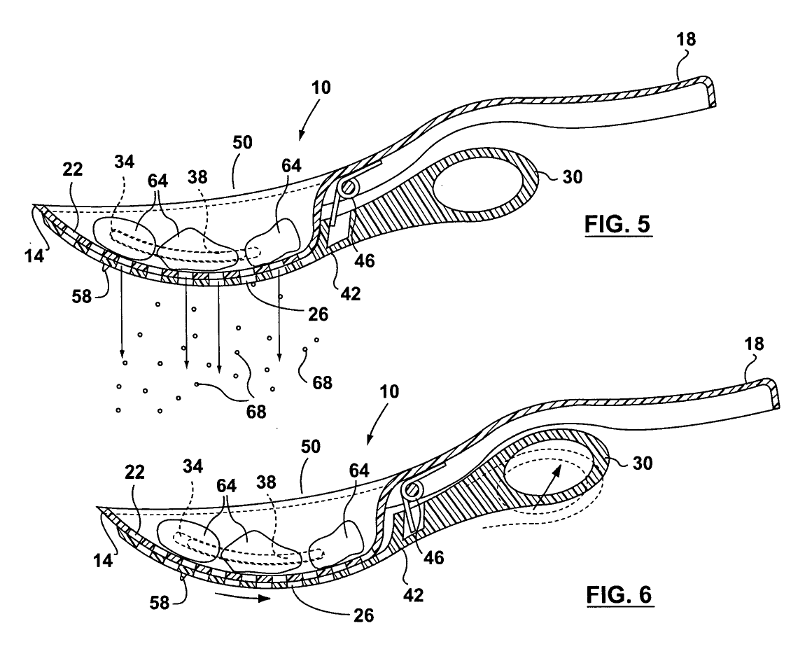

The arrangement of the scoop (14) and cover (42) can be varied so that in the first position, the cover openings (26) are aligned with the scoop openings (22) (see FIG. 5). In this arrangement, squeezing of the trigger (30) would result in the cover (42) moving to the second position (see FIG. 6) resulting in the openings (22, 26) no longer being aligned. In the second position the cover (42) would matingly cover the scoop openings (22) so that litter granules (68) could not pass freely therethrough.

1. An animal refuse scoop comprising:
(i) a scoop;
(ii) a handle attached to the scoop;
(iii) the scoop defining a top surface and a bottom surface, and a plurality of openings therein, the openings being defined to allow granules to pass therethrough;
(iv) a cover having a solid body and a trigger attached to said solid body, the solid body defining a plurality of openings therein, the solid body being slidably attached to the scoop and adjacent to the scoop bottom surface and adapted to matingly cover the scoop openings in a first position to prevent the passage of granules through the cover openings; and
(v) the cover solid body being adapted to slide to a second position by pulling of the trigger, wherein the cover solid body openings align with the scoop openings to allow the passage of granules through the scoop and cover openings.

2. An animal refuse scoop comprising:
(i) a scoop;
(ii) a handle attached to the scoop;
(iii) the scoop defining a top surface and a bottom surface, and a plurality of openings therein, the openings being defined to allow granules to pass therethrough;
(iv) a cover having a solid body and a trigger attached to said solid body, the solid body defining a plurality of openings therein, the solid body being slidably attached to the scoop and adjacent to the scoop bottom surface and adapted to align with the scoop openings to allow the passage of granules through the scoop and cover openings in a first position; and
(v) the cover solid body being adapted to slide to a second position by pulling of the trigger wherein the cover solid body matingly covers the scoop openings to prevent the passage of granules through the cover openings.

3. The animal refuse scoop as defined in claim 1 further comprising a biasing means attached to the scoop, the biasing means engaging the cover to bias said cover into the first position.

4. The animal refuse scoop as defined in claim 2 further comprising a biasing means attached to the scoop, the biasing means engaging the cover to bias said cover into the first position.

5. The animal refuse scoop as defined in claim 1 wherein the biasing means is a wound coil.

6. The animal refuse scoop as defined in claim 2 wherein the biasing means is a wound coil.

7. The litter scoop as defined in claim 1 further comprising a plurality of fingers attached to the cover solid body.

8. The litter scoop as defined in claim 2 further comprising a plurality of fingers attached to the cover solid body.
